(19) United States
(12) Patent Application Publication
(10) Pub. No.: US 2007/0160944 A1
(43) Pub. Date: Jul. 12, 2007

(54) Automatic gaslight igniter/controller and burners

(76) Inventors: Arnold W. Knight, New Brighton, MN (US); Andrew W. Knight, Fridley, MN (US)

Correspondence Address: ARNOLD W. KNIGHT, 2105 MISSISSIPPI CIRCLE, NEW BRIGHTON, MN, 55112, US

(21) Appl. No.: 11/643,123

(22) Filed: Dec. 21, 2006

Related U.S. Application Data
(60) Provisional application No. 60/754,475, filed on Dec. 28, 2005.

(51) Int. Cl. F23Q 1/04; F23Q 3/00; F21H 1/00; F23Q 9/00; F23Q 7/12; F21L 19/00

(52) U.S. Cl. 431/264; 431/254; 431/255; 431/278; 431/100; 362/179

(57) ABSTRACT

A method and apparatus is defined for automatically igniting and controlling a gaslight to turn ON the gaslight in the evening and turn OFF the gaslight in the morning or alternatively, using a switch or timer to turn the gaslight on and off. The gaslight may be either a mantle type burner or an open flame type burner. The igniter consists of a high voltage spark generator that is controlled by a microcontroller to enable the spark when the microcontroller senses that darkness has occurred or a preset time of day has occurred. The spark is generated across a spark probe gap that is positioned in an optimum location to ignite the gas/air mixture. We and others have been manufacturing gaslight igniters for several years and this patent pertains to recent concepts and implementations that greatly improve the automatic igniter/burner utility and operation.

The physical parameters of the device are also important. The device is sized so that it will fit easily inside of a 3-inch lamppost, or install easily within most gas lamp heads. The device is flexible in configuration to allow the burner/probe to be oriented axially with the igniter, or oriented perpendicular to the igniter to provide great flexibility in using the igniter with various burners and gas light heads. Quick disconnect fittings for gas and low voltage electric make the igniter/burner assembly easy to change without tools, similar to changing a light bulb.

### CROSS REFERENCE TO RELATED APPLICATIONS

This application claims the benefit of PPA Ser. No. 60/754,475 filed 2005 Dec. 28 by the present inventors.

### FEDERALLY SPONSORED RESEARCH

Not applicable

### SEQUENCE LISTING OR PROGRAM

Not applicable

### BACKGROUND OF INVENTION

1. Field of Invention

This invention pertains to automatic gaslight igniters/controllers and burners for use with indoor or outdoor automatic gaslights, including natural gas, propane and other fuels. Both open flame and mantle type burners are used and the igniter works with most existing gaslights manufactured or in operation today. The small size and flexibility of the physical unit, which can be configured in several ways to meet specific installation requirements, allows its use with most gas lights. Compressing the igniter, solenoid valve, burner and probe into an integrated unit that is as easy to change as a light bulb is an important feature of this invention. Direct wire probes and side ignition of an open flame burner further enhance the gaslight operation.

1. Description of Prior Art

Automatic gas light igniters have been used with limited success for several years. U.S. Pat. No. 4,830,606 describes a unit that is operated from a solar charged battery. Problems with maintaining a charge in the battery are apparent. Also the design described in the referenced patent uses discrete components rather than a microprocessor and lacks the flexibility to meet many gaslight installation requirements. Previous igniter configurations have components that are distributed about the gaslight head, post, wall bracket and other locations. None can be changed without tools, as easily as changing a light bulb. U.S. Pat. No. 5,980,238 describes an igniter used with a mantle burner with many of the initial claims defining manual gaslight burners that have been used for more than 50 years. It defines an installation that uses an extra oversize section of pipe to extend the post height to house some of the igniter hardware but does not mention an integrated plug-in igniter/burner assembly that requires no extra housing.

### BACKGROUND OF INVENTION—OBJECTS AND ADVANTAGES

Advantages and features of the Knightronix Knightlighter automatic igniter/controller for gas-lights include:
1. Small igniter size; fits in the bottom of most gaslights or within a 3 inch post.
2. Igniter/burner can be changed without tools as easily as replacing a light bulb.
3. Direct wire probe requires no ceramic probe holder.
4. Side ignition probe will not soot-up, even with propane.
5. Igniter works with propane or natural gas.
6. Optional brass or copper cover provides a heat shield and hides wires and solenoid valve.
7. Igniter works with mantle or open flame burners.
8. Battery models operate on a 6 VDC Battery with 4 AA alkaline batteries lasting over one year.
9. The 24 VAC igniter operates on less than 100 milliamps of current while igniting and about 10 milliamps when quiescent.
10. A restrictor orifice at the gas source shutoff valve limits gas flow to a safe level in case a gas-line is cut.
11. Mantle powered solar charger generates enough power from lighted mantles to operate the igniter and maintain battery charge because of the low operating current of the igniter. Any other solar charging is a bonus.

A very significant advantage of the plug-in automatic igniter/burner is that it provides easy field maintenance by allowing the service person to change out a defective unit with a replacement unit without tools and then return the defective unit to the shop or manufacturer for repair. A manual burner can be plugged in to provide light until the automatic unit is re-installed.

Gaslight installations are distributed all over the country and world. It is not practical to send a trained maintenance technician out to the gaslight location to repair the unit. Even if a trained technician did go to the gaslight site, it is very difficult to work on a hard-mounted gaslight/burner with distributed components when it is very cold or hot or when it is windy, snowing or raining. By making the automatic igniter/burner pluggable and easily interchangeable in the field without tools, the maintenance problem is greatly reduced and manageable.

### SUMMARY OF THE INVENTION

Accordingly it is the primary objective of the present invention to provide a small, low cost, flexible and reliable automatic gas light igniter/controller that can be used with most gaslight manufacturer's gaslights.

The basic igniter/controller is a microcontroller-based unit with electrical power provided by a low voltage 24 VAC source, from a transformer connected to the house 120 VAC, 60 Hz power. A Cypress CY7C 53120 neuron chip is used as the microcontroller, which can also be interfaced with a computer to control the gaslights remotely and individually, if desired. When operated outdoors, the primary objective of the igniter/controller is to ignite the gaslight when darkness occurs and turn the light off when daylight occurs, saving 50% on gas usage. The operation of the igniter/gaslight can also be controlled from a manual electrical switch, timer or remote control. A secondary objective of the controller is to turn off the gas if, for some reason, the gaslight fails to light or re-light. Or in the case of street lights, to leave the gaslight in the continuous ON condition, as desired by some municipalities.

An alternative model of the igniter/controller operates on battery power, with 4 AA alkaline batteries lasting over one year. Rechargeable batteries may be used, which are charged from a small solar panel, with light energy from the mantles, or energy from the sun.

A further and important objective is to provide a small, flexible package configuration that can be used in most gaslight installations. The igniter package is configured to be installed directly in the bottom of the gaslight head. This configuration is integrated into a small package that can be easily replaced, similar to replacing a light-bulb, if service is required. A quick connect fitting allows unsnapping the entire igniter/burner/battery assembly. The low-voltage power to the 24 VAC igniter uses an electrical connector for easy connection.

An alternative package is made for installing the igniter in a standard 3-inch diameter lamppost, near the top of the post, but requires removal of the gaslight head to change the igniter.

### DRAWING—FIGURES

### Brief Description of the Drawings

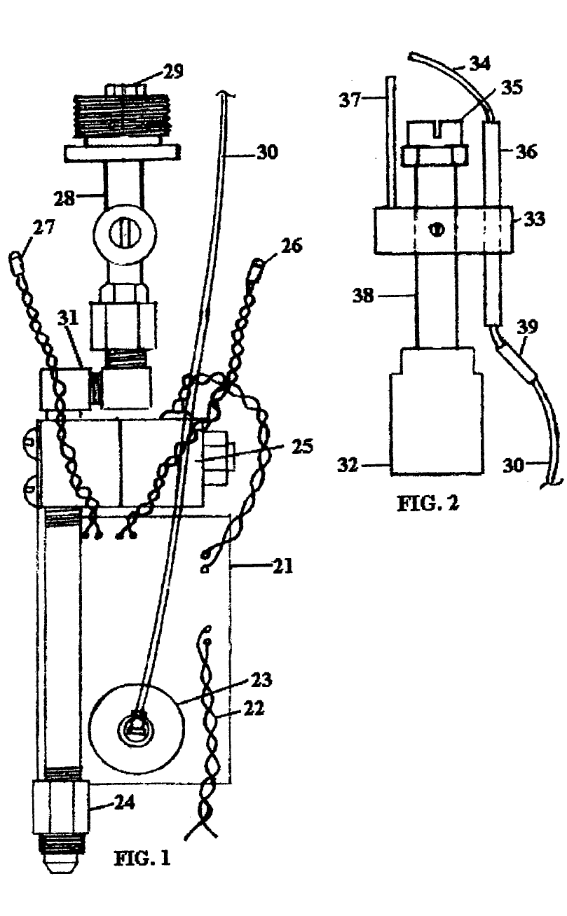

FIG. 1 is a drawing of a basic igniter/controller package, used with a common manual gaslight valve.

FIG. 2 shows a basic open-flame burner with the high voltage spark probe.

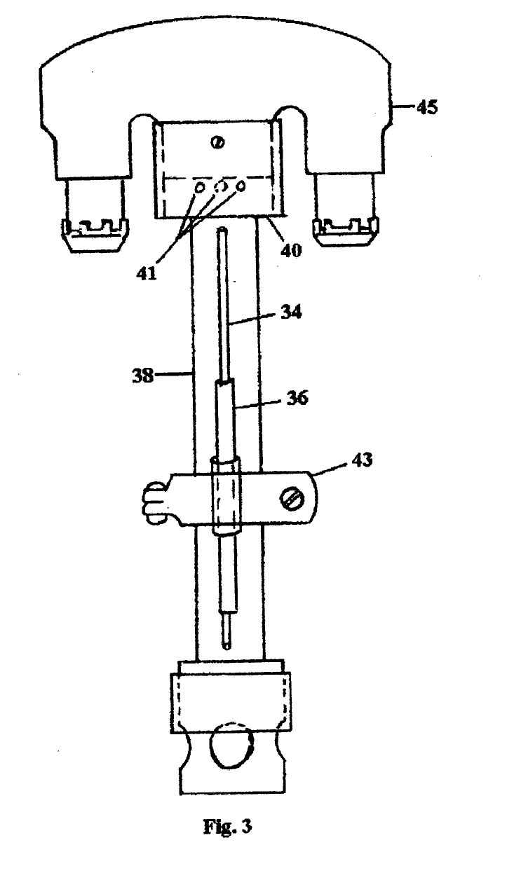

FIG. 3 shows a mantle burner with the spark probe attached.

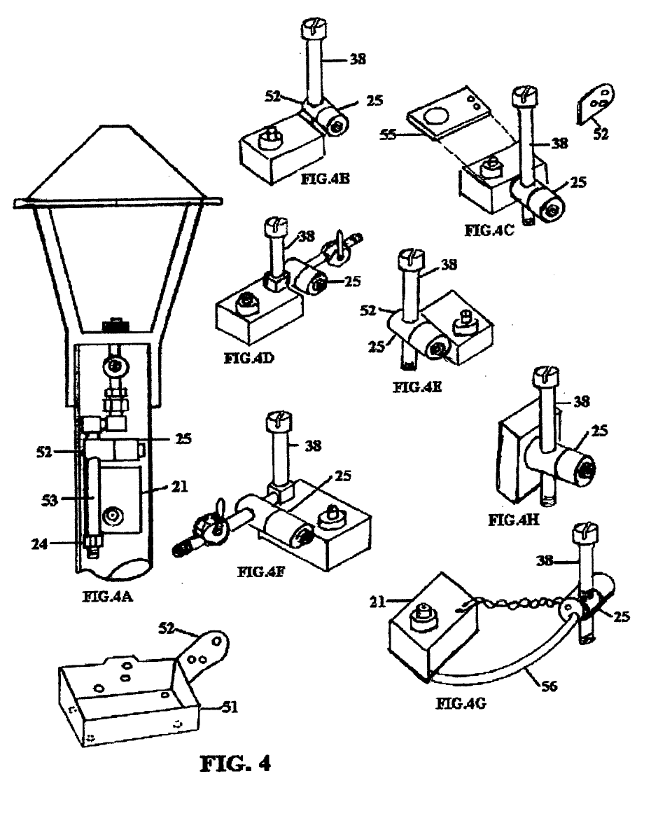

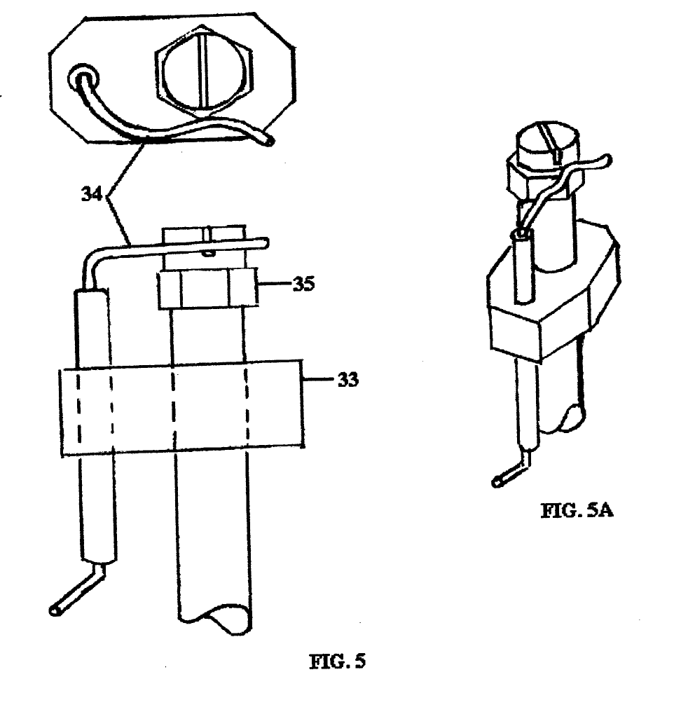

FIG. 4 shows the basic igniter/controller installed in a 3-inch diameter lamppost.

FIG. 4A through 4H show various configurations that can be made with the igniter/controller box for operating with many different gaslight installations.

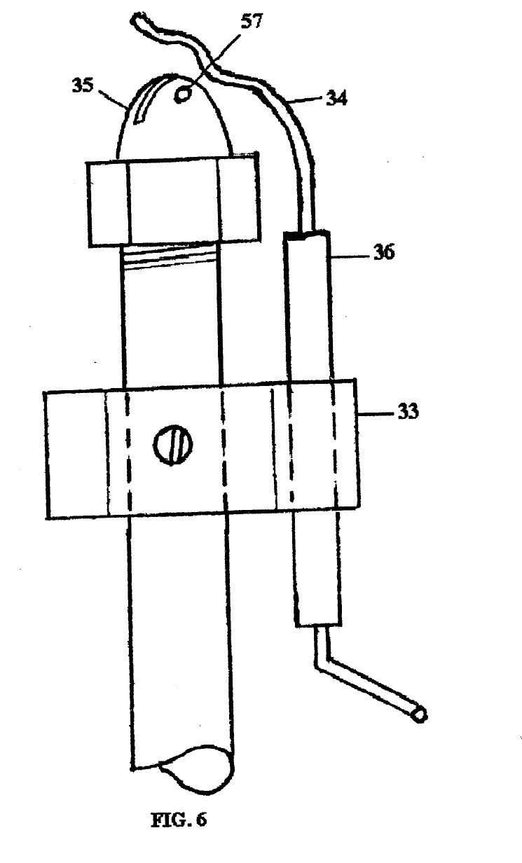

FIG. 5 shows a probe block with a ceramic insulator and spark probe adjacent to the burner slit.

FIG. 6 shows a burner tip with a small pilot burner hole and a tangent spark probe.

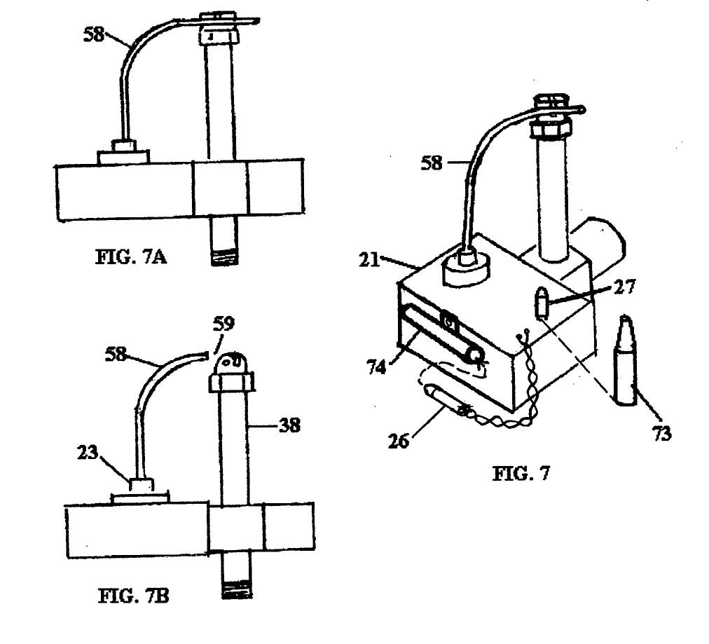

FIG. 7 shows direct wire probe configurations.

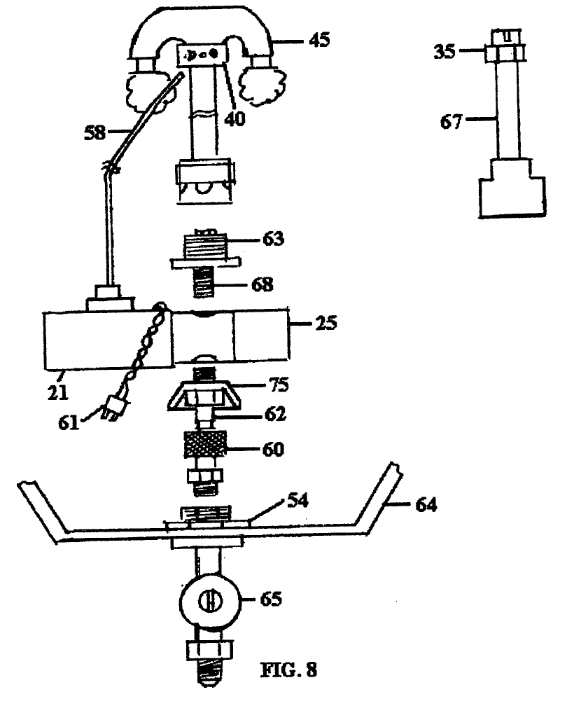

FIG. 8 shows a side-mounted solenoid igniter with a quick connect fitting installed on a manual valve with both mantle and open flame burner options.

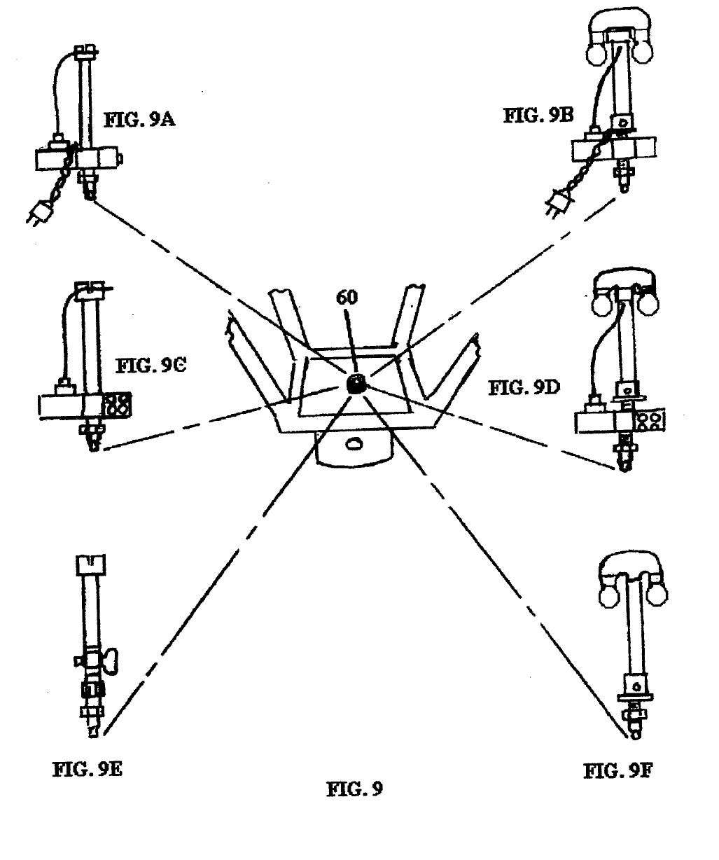

FIG. 9 shows an array of igniters that can be plugged into a common gaslight receptacle.

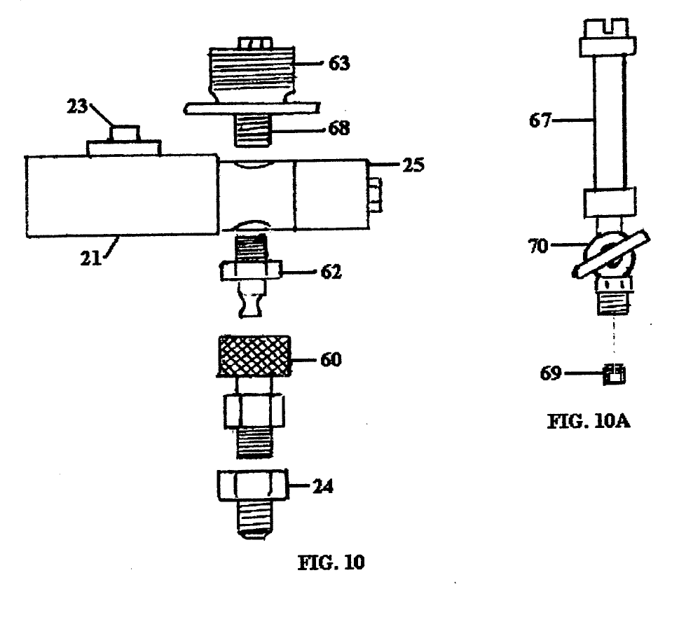

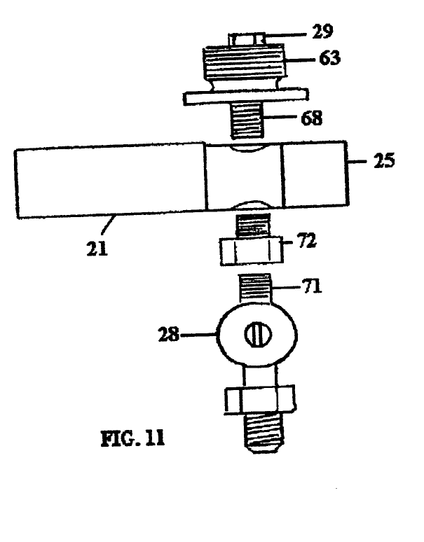

FIG. 10 shows a side-mounted solenoid/igniter with a quick connect fitting for connection directly to the gas-line input tubing without using a manual valve.

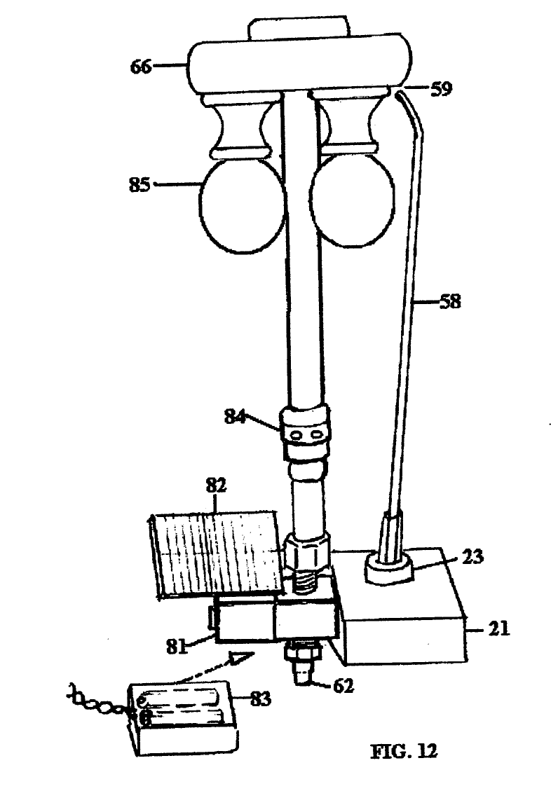

FIG. 11 shows a modified manual valve with mantle burner adapter above the solenoid valve and the lower part of the manual valve connected to the bottom of the solenoid valve.

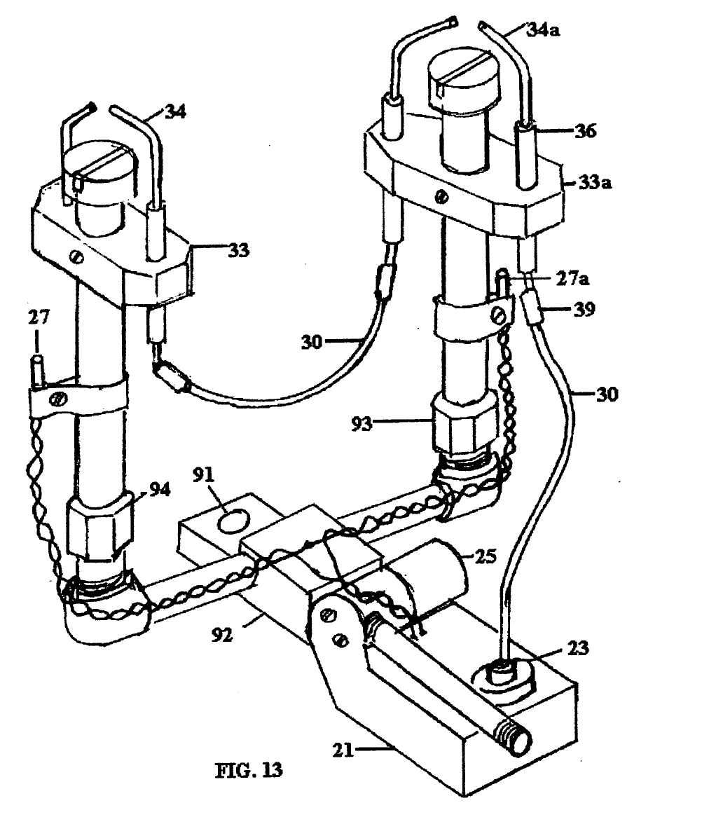

FIG. 12 shows a solar panel charged battery igniter for a mantle burner.

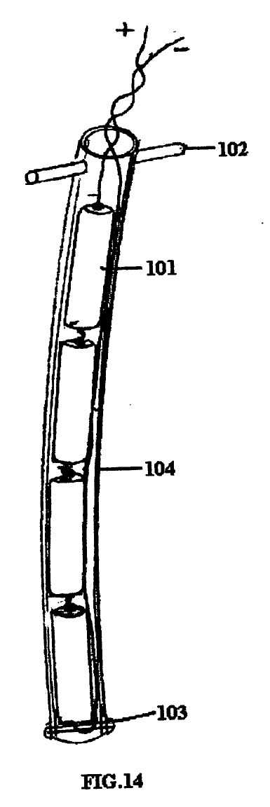

FIG. 13 shows a dual open flame burner with high voltage spark probes in series and with photo sensors in series.

FIG. 14 shows a battery pack enclosed in a plastic tube which can be installed through the bottom of a post-mounted gaslight head to hang in the post.

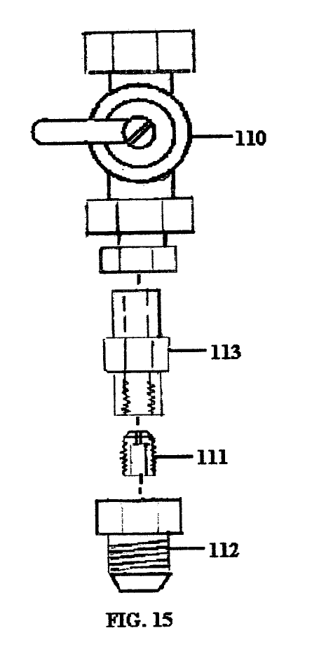

FIG. 15 shows a gas-line restrictor valve for limiting gas flow to a safe level in the event that the line to the gaslight is severed.

### DRAWINGS—REFERENCE NUMERALS

21—igniter box
22—power input leads
23—high voltage transformer
24—flare fitting
25—solenoid valve
26—daylight photo-sensor
27—flame photo-sensor
28—manual shut-off valve
29—burner orifice
30—high voltage wire
31—right angle fitting
32—adapter base
33—brass probe block
34—spark probe
35—burner tip
36—ceramic insulator
37—probe return wire
38—burner stem
39—pin connector
40—pilot burner ring, mantle
41—pilot burner holes
42—
43—insulator clamp
44—
45—2-mantle burner
46-50
51—potting box
52—potting box ear
53—gas input nipple
54—fastener nut
55—igniter box cover
56—ground strap
57—pilot burner pin-hole
58—direct wire probe
59—spark gap
60—quick Connect fitting, female
61—electrical connector
62—quick connect fitting, male
63—mantle burner adapter
64—gaslight head
65—modified shut-off valve
66—3-mantle burner
67—open flame burner
68—short nipple, ⅛ NPT
69—burner orifice, set-screw type
70—T-handle shutoff valve
71—threaded shut-off valve
72—extender fitting
73—flame sensor sheath
74—daylighy sensor sheath
75—coupler cap
76-80
81—latching solenoid valve
82—solar panel
83—battery pack, rechargeable
84—air intake
85—mantles
86-90
91—mounting bolt hole
92—mounting block
93—insulator coupler, nylon
94—brass coupler
95-100
101—battery
102—cross-bar pin
103—retainer pin
104—plastic tube
105-109
110—gas shut-off valve
111—gas fuse orifice
112—flare fitting, ¼ NPT
113—hex nipple, +B 1/8 NPT

### DETAILED DESCRIPTION OF THE PREFERRED EMBODIMENT

The baseline automatic igniter/burner configuration is shown in FIGS. 1, 2 and 3. These figures show a post-mounted igniter installed in the top of a 3-inch diameter lamp post, using a Gas Light Manufacturing model GLV-100 manual shutoff valve 28 to hold the igniter to the gas-lamp head. This is the same valve used with many manual gaslights.

The igniter 21 shown in FIG. 1 operates either with the open flame burner shown in FIG. 2 or the mantle burner shown in FIG. 3.

The igniter/microcontroller board is potted in an aluminum potting box 51 to form the igniter 21. Low voltage 24 VAC power is connected to the power leads 22. Natural gas, propane or other fuel line is connected to the male flare fitting 24. A solenoid valve 25 is controlled by the microcontroller. A daylight photo-sensor 26 senses ambient daylight and signals the microcontroller to ignite the gaslight at dusk and turn it off at dawn. The flame photo-sensor 27 monitors the burner flame and signals the microcontroller to keep the solenoid valve open as long as the flame is present. If the flame goes out, it signals the igniter to re-ignite the flame and then, if it fails to re-ignite, shut off the gas solenoid valve 25.

The right angle fittings 31 are used to center the igniter box within the post. The high voltage transformer 23 generates a spark that is sent to the burner spark probe 34 over the high voltage wire 30. The orifice 29 controls the amount of gas sent to the burner and the size of the flame.

The basic open flame burner is shown in FIG. 2. The adapter base 32 is a brass fitting that is screwed onto the manual valve 28 using the wrench flats to aid the process. A ⅛ National Pipe Thread (NPT) nipple of various length forms the burner stem 38. The burner tip 35 is a standard brass ⅛ NPT cap with a 0.010 inch slit sawed into the cap to form the flame. A brass probe block 33 is attached to the burner stem, using a set screw. This block holds the ceramic insulator 36 which holds the NiChrome wire spark probe 34 in place. The high voltage wire 30 is attached to the spark probe 34, using a connector pin 39. The spark probe return 37 is mounted on the brass probe block. A 0.2 inch nominal spark gap is used and the spark gap is about 0.75 inches above the burner tip.

The mantle burner with spark probe is shown in FIG. 3. It is usually constructed from a common mantle burner and modified to operate with a high voltage spark probe. The ceramic insulator 36 is attached to the burner stem 38, using an insulator clamp 43 to hold the spark probe wire 34 in place. The high voltage wire is attached to the bottom of the probe using the same type of pin connector 39 that is used for the open flame probe. The mantle burner is modified to provide a pilot burner by drilling three 0.078 inch diameter holes 41 at the top of the stem, with two holes on the front side and one on the back. The holes are covered with an aluminum ring 40 to form the pilot burner. The pilot burner is ignited by a high voltage spark from the probe to the ring. The ring also serves the purpose of igniting both mantles at once, when the gas filled ring is ignited.

Automatic Igniter Box Configurations

The automatic-igniter, which comprises the printed circuit board with the microcontroller and the high-voltage-spark generator, is housed in aluminum, copper or other type of potting box 51, shown in FIG. 4. Potting material is used for protection of the electronics from adverse environmental conditions. The potted igniter package is used in several configurations to meet many different installations for automatic gaslights. These configurations include: 1) Vertical post mount, 2) Perpendicular open flame burner with gas input horizontally, 3) Vertical burner with gas input from the bottom. 4) Side mounted solenoid valve with a perpendicular burner used for the plug-in assembly, 5) Ear-mounted solenoid valve perpendicular on the end of the igniter box, 6) Ear-mounted on the corner of the box with ear bent at 90 degrees to the long edge of the box. All of the above configurations and others are available, using a single potting box 51 with a solenoid valve mounting ear 52 or holes for mounting the solenoid on the side of the box as shown in FIG. 4. The potting box works equally well with both the solenoid valve 25 and the latching solenoid valve 81.

FIG. 4A through 4J show different configurations that can be made using the same igniter potting box 51.

The basic post-mounted igniter 21 is shown in FIG. 4A, installed in the top of a 3-inch post. This igniter has the solenoid valve 25 mounted on an ear 52 of the potting box, with the gas input nipple 53 parallel with the long side of the box. The gas-line is connected to the flare fitting 24. FIG. 4B has the solenoid valve 25 mounted on the box ear 52 at 90 degrees and the burner stem 38 perpendicular to the box. FIG. 4C has the solenoid valve 25 mounted on the side of the igniter box for easy installation inside of the gaslight head on the floor of the lamp. This is the configuration used for the plug-in igniter/burner assembly. The box ear 52 is normally cut off of the plug-in assembly. FIG. 4D has the solenoid 25 input reversed from FIG. 4A, with the burner stem 38 perpendicular to the box.

FIG. 4E has the box ear 52 bent at 90 degrees with the solenoid valve 25 attached so that the burner stem 38 is perpendicular to the top of the box. FIG. 4F is similar to 4D with the solenoid valve 25 attached to the box ear 52 and the burner stem 38 perpendicular to the top of the box. FIG. 4G has the solenoid valve 25 and burner stem 38 separated from the igniter 21 for special installation conditions. It requires a good electrical ground strap connection 56 between the igniter box 21 and the solenoid/burner 38. FIG. 4H has the solenoid valve 25 mounted on the bottom of the potting box 51 to fit in a tight space such as the GLM 1700 round gaslight. Other configurations are possible and can be made to fit with most known gaslights. A copper or brass cover 55 can be used to cover the potted igniter box to provide a heat shield and for aesthetics, if desired.

Open Flame Burner Configurations

Another objective of this invention is the design of various new open flame burner configurations similar to that shown in FIG. 2. The manual shut-off valve 28 is used with some of the burners. A brass adapter base 32 with 2 flats for wrench use, is made to screw onto the manual valve 28. This base accepts ⅛ inch NPT brass pipe or nipples to form the burner stem 38. The base 32 can also be adapted to other custom burners. Burner tips 35 are made by cutting a slit across the end of a brass cap nut. Any of various cap nuts may be used to form burner tips with a single slit and other variations, such as cross slits or holes. The burner tip slit is extended down the edge of the cap to provide a wider flame and also to generate a gas-air mixture that can be readily ignited at the lower edge of the flame.

Gas emitted from the side of the slit shown in FIG. 5 can be easily ignited by the spark probe 34 as the gas mixes with enough air to make it combustible. The spark probe 34 is positioned so that it lies perpendicular to the burner slit. The probe 34 is formed and positioned so that the spark gap is between the tangent point of the probe wire 34 and the burner tip 35 at the base of the slit. A probe that is perpendicular to the slit as shown in FIG. 5 works much better than generating the spark from the end of the probe wire. This phenomenon was discovered by experimentation. It would seem logical that the spark should be emitted from the end of the wire as has been done conventionally, but this never achieved reliable ignition. Sparking from the side of the wire ignites the gas/air mixture very reliably. This is considered a patentable feature as it has not been used previously and is not readily apparent.

The method shown above in FIG. 2 uses a wire spark probe 34 above the burner tip 35 that sparks to a probe return wire 37 with a gap of about 0.2 inch. When placed about ¾ inch above the burner tip and perpendicular to the slit, it provides good ignition properties but is subject to sooting up. A Ni-chrome or similar high temperature wire is used for the spark probe 34, which will withstand high temperature operation (red hot) for long periods. The return wire 37 can be either Ni-chrome or other type of wire as it is not in direct flame. This igniter method is not claimed as part of this invention as it has been used by several manufacturers, including ourselves for several years.

An alternative method FIG. 6 to provide an easily ignited burner uses a small pilot burner pin-hole 57 of about 0.017 inches diameter, drilled close to the slit on the corner of the burner tip 35. This provides a point for ignition from the tangent probe wire 34.

The probe 34 is supported by the ceramic insulator 36 and block 33 and is extended through the flame to provide a second method of sensing flame using the ionized gas detector. The voltage generated by the flame ionized gas can be used to sense flame present or the ionized gas rectification principal can be used.

Direct-Wire Probe Configuration

FIG. 7 shows the direct wire probe configuration. The direct wire probe 58 is used to deliver the high voltage spark from the transformer 23 via the spark gap 59 to the burner tip. This has several advantages. First, it is less costly than using the ceramic insulator and probe wire. Second, the direct wire is separated from the burner stem 38 such that the spark can not be shorted to the stem on its way to the spark gap. There is no loss in the spark intensity along its path to the spark gap. The direct wire provides the shortest path to the spark gap and can be used with most burner tips including burners with ceramic tips by sparking to the metal tip that holds the ceramic tip. It also provides an uncluttered burner configuration.

Operating the Igniter in a Manual Mode from a Switch

Some customers desire a manual igniter that operates only from a switch. The gaslight ignites when the switch is turned on and goes out when the switch is turned off, whether it is operated during the day or night. The Knightlighter igniter can be operated in this mode as follows.

A flame-sensor sheath 73 is installed over the flame sensor to restrict ambient daylight while still allowing the flame sensor to be activated by the flame or mantle. The flame sensor with the sheath covering it must be pointed at the yellow part of the flame or the lighted mantle. When the flame is not present, the flame sensor shall be pointing at the darker top inside of the gaslight head. The daylight sensor must be covered with tape so it does not see daylight or alternatively, the sensor can be un-installed.

Daylight Sensor Sheath

A daylight photo-sensor 26 can be installed in a sheath 74 which is attached to the side of the igniter box 21, such that the daylight sensor views the ambient outside light without seeing the gaslight flame or mantle. This alleviates the requirement to install the daylight photo-sensor separate from the igniter and makes the igniter fully pluggable and easier to exchange. The sensor must have a clear view of the outside world through the glass pane without seeing light reflections from the burner. This configuration may not work with all gaslights if the outside view is blocked.

Integrated Igniter/Burner/Solenoid Valve/Spark Probe

A major feature of this invention is the concept of combining the entire igniter/burner/solenoid valve/spark probe shown in FIG. 8 into an integrated unit with quick connect fittings so that the unit can be exchanged without tools as easily as changing a light-bulb. This is important from a maintenance standpoint, particularly during cold weather. It works with both mantle and open flame burners. The current size of our unit allows this capability and future models will reduce the size even further, with an igniter box about ½ the size of the present unit. This easy interchangeability is not presently available in any competitive designs. Quick-connect fittings 60 and 62 are used to couple the igniter/solenoid valve 25 to the manual valve 65 that is held in place by a fastener nut 54. A coupler cap 75 may be used on fitting 62 to keep dirt and moisture out of the coupler. The incoming gas-line is connected to the manual valve 65 and an electrical connector 61 is used to connect 24 VAC power to the igniter. The quick connect coupler pair now used is the Parker HF Series quick coupler. It has an integral shut-off valve that shuts off the gas supply if the burner is removed.

In the battery operated unit the batteries are packaged with the integrated unit and are replaced with the unit. This concept works equally well with the mantle burner 45 as with the open flame burner 67. A mantle burner adapter 63 is used to connect the burner to the solenoid valve 25. This adapter can be machined from scratch or the end of a manual valve can be cut off and used to fabricate the adapter, using a ⅛ NPT short nipple 68 to connect the adapter. The male quick connect fitting 62 screws into the lower side of the solenoid valve 25 and plugs into the female quick connect receptacle fitting 60 to provide the interface between the burner/igniter and the gas light head 64. A manual shut-off valve 65 is modified by drilling and tapping the orifice socket to ⅛ inch NPT to accept the ⅛ NPT quick connect fitting 60. Alternatively, a quick connect fitting 60 can be used that is sized for 1/16 NPT to fit directly to the manual valve 65 with no modification required to the valve.

FIG. 9 shows a montage of several different igniter/burner configurations that can be interchangeably installed is the same gaslight head, simply by unplugging one burner and plugging in another into a quick-connect receptacle 60. The following plug-in assemblies can be used.

FIG. 9A is a 24 VAC igniter/open-flame burner.

FIG. 9B is a 24 VAC igniter/mantle burner.

FIG. 9C is a battery operated igniter/open-flame burner.

FIG. 9D is a battery operated igniter/mantle burner.

FIG. 9E is a manual open flame burner.

FIG. 9F is a manual mantle burner.

A manual plug-in burner can be kept on hand to replace a faulty automatic burner temporarily while the defective burner is being repaired. Or a manual burner or second automatic burner can be easily interchanged with another burner during special holidays or other event to provide a different mood.

A battery igniter/burner can be used to replace a 24 VAC igniter/burner without using the 24 VAC power. However a 24 VAC igniter/burner can not replace a battery unit unless 24 VAC is available in the gaslight head.

Dimmer Controlled Gaslight Burner

A dimmer burner is an electronically controlled mantle burner that burns at full brightness during the night and then is turned down to a dim mode, just bright enough to maintain the mantle flame during the day. A dimmer mode can be made using the mantle burner of FIG. 12. The only modification required is to drill about a 0.017 inch diameter by-pass orifice in the latching solenoid valve 81 (FIG. 12), from the input port to the output port. The igniter function can still be maintained to relight the burner if it goes out completely. Alternatively, the dimmer burner can be operated without an igniter, but must be relit manually. The dimmer configuration uses about 25% more gas than an igniter controlled gaslight that is turned off completely during the day. The dimmer controlled burner can also be a plug-in burner, using the quick connect fitting 62.

FIG. 10 shows an alternate method for the quick-connect configuration. This configuration eliminates use of the manual valve and depends on the shut-off valve within the quick-connect fitting 60, to shut off the gas when the igniter/burner is removed. The female quick-connect fitting 60 is connected directly to a ¼ inch NPT flare fitting 24, which connects to the incoming gas-line. A mantle burner adapter 63 is used to connect the mantle burner to the solenoid valve 25. This can be machined from scratch or the end of a manual valve can be used to fabricate the adapter using a ⅛ NPT short nipple 68. Open flame burners 67 can be screwed directly into the solenoid valve, thus eliminating the need for the adapter 63. An orifice 69 fits into the lower end of the T-handle flame adjustment valve 70, or a ⅛ NPT Hex nipple can be tapped to accept an orifice made from a ¼×20 brass set screw that has been drilled to the proper orifice size, nominally 0.028 inch diameter.

Another method for assembling the igniter/solenoid valve to a manual shut-off value without using the quick-connect fitting is shown in FIG. 11. This method uses a manual valve 28 that is cut off just below the burner adapter 63. The mantle burner adapter is drilled and threaded for ⅛ NPT short nipple 68. The remaining part of the valve is threaded for ⅛ NPT male thread 71. An extender fitting 72 is used to connect the solenoid valve 25 to the threaded manual valve 71 to maintain the original length. This can be installed in several lamp configurations but does not provide quick-connect capability.

Solar Powered Igniter

FIG. 12 shows a solar powered mantle burner with the rechargeable battery pack 83 used to power the igniter. A 3-mantle burner 66 with the mantles spaced close enough together so that all mantles light when one is lit is shown. A direct wire probe carries the high voltage from the transformer 23 to the spark gap 59. The latching solenoid valve 81 is mounted on the side of the igniter box 21. The rechargeable battery pack 83 is installed next to the solenoid valve. The solar panel 82 is mounted on the solenoid valve and facing up. The solar panel is a model YH60X60 obtained from Yuhuan Solar Energy Source Company. The output voltage from the solar panel is high enough to provide charging current into the battery when powered only from the mantle flame. In addition, it also provides charging current from sunlight or shaded day light. Because of the low current requirement of the igniter, the charging current from the mantle flame is adequate to operate the igniter and to maintain battery charge as well. The total assembly shown in FIG. 12 can be installed in a gaslight head using a quick connect fitting 62 for easy interchangeability. This assembly can also be easily converted to a dimmer gaslight by drilling a small orifice of about 0.017 inch diameter between the input port and the output port of the latching solenoid valve 81. The latching solenoid value currently used for battery operation is the ASCO JV139 series. The solenoid valve 25 used with the 24 VAC igniter is a KIP 1X1093 series.

Power Sources

The basic igniter operates either from a 24 VAC (or 24 VDC) low voltage source with other models operating from batteries. The preferred battery powered unit operates on 6 VDC batteries but other battery voltages can be used. Primary batteries such as four AA alkaline batteries will operate the igniter for over one year.

An alternative uses rechargeable batteries, such as Nickel Cadmium (NiCad), Nickel Metal Hydride (NiMH) or Sealed Lead Acid, that can be charged from solar panels or other means. A solar panel 82 is installed in the base of the gaslight head, above the latching solenoid valve 81 and attached to the solenoid valve.

The battery operated igniter/controller uses a latching solenoid valve 81 to control the gas to the burner. The solenoid operation is controlled by the microcontroller. The electrical circuit that drives the solenoid is designed to turn off the solenoid automatically, if the power is lost. This assures that the solenoid ends up in the off state and the gas is shut off when power is lost. Alternatively, the unit can be set up to stay ON if the igniter should fail. This configuration has been requested by some municipalities where the gaslights are used for street lighting to keep the gaslights in the on condition, if possible.

Other types of electrical generators are also envisioned for maintaining battery charge. These include Thermal-Photo-Voltaic or Thermal-electric where electricity is generated from the heat of the burner.

Dual Open Flame Burner

FIG. 13 shows a dual burner open flame fixture with automatic ignition using a single igniter 21. The two spark probes 34 and 34a are in series so that both probes are driven via the high voltage wire 30 by a single high voltage spark igniter. One spark probe block 33 has a single ceramic insulator and the second block 33a has two ceramic insulators. The high voltage spark thus appears across both probes, igniting both burners. Photo-sensors 27 and 27a are also in series and positioned so that each sensor views only its respective flame. Thus the two burners continue to spark until both flames light. One problem occurred that was unanticipated. If the farther burner 33 from the high voltage transformer lights first, the closer burner continues to spark and will ignite later. However, if the first burner 33a lights first, the second may fail to light. The reason was found to be conduction of the high voltage spark through the ionized flame to ground return of the first burner stem. The problem was resolved by using an insulating fitting 93 such as a nylon coupler. This isolates the first burner from ground return, thus assuring that the spark appears across the spark probe of the second burner and both burners light. Coupler fitting 94 is brass to provide a good return path to ground for the high voltage spark.

A custom block 92 is used to build the dual burner and a bolt located in hole 91 holds the burner to the bottom of the gas light head of a large gas lamp.

Battery Stick

FIG. 14 shows a battery pack stick used to power battery operated igniters for some post-mount applications. The battery-pack, either primary alkaline AA or rechargeable batteries is fabricated using a PVC or other plastic tube 104. The batteries are soldered together in series to form a battery pack when installed in the plastic tube. A cross bar pin 102 is installed at one end to hold the battery pack from dropping down the inside of the post. A plastic pin 103 is installed across the bottom of the tube to hold the batteries in place. The plastic tube 104 can be potted to protect against corrosion of the interconnecting leads.

Gas-Line Safety Device; “GAS-FUSE”™

A manual shut-off valve 110 is normally used at the gas meter or source of the gas-line supply to the gaslight. A safety device for limiting the gas flow to a gas-line supplying gas to a gaslight or other appliance is shown in FIG. 15. A “Gas-fuse” orifice 111 is installed in a ⅛ NPT Hex nipple fitting connected to the shut-off valve 110 to limit the gas flow to a rate that will just supply enough gas for reliable gaslight operation. This “Gas-fuse” orifice is slightly larger that the gaslight burner orifice 29, to maintain adequate gas flow to the gaslight. Thus, if the gas-line were to be cut or spring a leak, the amount of gas escaping would be limited to a very safe level. Normally, a ¼ inch internal dimension (ID) gas-line is used to supply the gaslight and without the restrictor, a significant flow and fire danger can result if the gas-line is broken. A gaslight uses about a 0.028 inch diameter orifice for 2500 BTU per hour operation so a 0.040 inch diameter orifice can be used for restricting the flow at the gas meter to a very safe level while still supplying adequate gas to the gaslight. When more than one gaslight is operated on a gas-line the orifice shall be sized to accommodate the additional gas required.

### CONCLUSION, RAMIFICATIONS AND SCOPE

This patent covers several important concepts and features that improve the operation of both mantle and open flame automatic gaslights. A primary improvement is an integrated igniter/solenoid valve/burner and spark probe that is plugged into a quick connect receptacle in the gaslight base and can be easily exchanged without tools, similar to replacing a light bulb. This plug-in feature also includes dimmer controlled gaslight mantle burners and manual mantle burners. This feature will revolutionize the way that gaslights with igniters or dimmers are designed, fabricated, installed and maintained. Because of the wide distribution of gaslight installations, it is not practical to send a trained technician out to an installation to service a gaslight. The traffic congestion and miles to be driven are prohibitive. Travel time for the technician is also costly. Weather conditions do not always cooperate either.

Gaslights are not as numerous as electric lights and there is not enough technical work to support a dedicated technician in a smaller area or suburb. Training technicians to service and maintain existing gaslights with igniters that have components distributed throughout the gaslight is not practical as it usually requires removal of the entire gaslight and disassembly of the igniter installation. Experience shows that reassembling the gaslight is problematic in that more damage may be done during reassembly than that originally encountered. By making the automatic igniter/burner a plug-in unit, the home owner or a relatively untrained technician can change out a defective igniter/burner and return it to the shop, depot or manufacturer for service and repair. Spare igniters or manual plug-in burners can provide interim gaslight operation. Dimmer controlled burners may also be plug-in assemblies.

This invention also defines a multipurpose igniter potting box that can be used for custom installations where the application does not allow plug-in operation. An example is the use of the igniter for an eternal flame light in a synagogue where aesthetics are the primary concern. Another is an igniter installed in the top of a post for customers that desire such installation. It should be noted that the plug-in igniter/burner is one configuration of the multi-purpose potting box.

There are several other features of this invention that have proven to be significant improvements over other implementations now in use in the industry. One is the side ignition burner that provides reliable ignition and prevents soot build up, even with propane burners, while still maintaining the ion flame sensor capability.

What is claimed is:

1. An automatic igniter/open flame burner apparatus for gaslights comprising an electronically controlled igniter, solenoid valve, open flame burner and spark probe wherein said apparatus turns on the gaslight in the evening and turns off said gaslight in the morning and as timing is preset.

2. The apparatus of claim 1 wherein said igniter, solenoid valve, open flame burner and spark probe are integrated into a single unit that is installed within the gaslight head using a quick connect fitting and said apparatus is easily changed without tools.

3. The apparatus of claim 1 wherein a direct wire probe with the spark emanating from the side of said direct wire probe tangent to the burner slit provides a means to reliably light the flame and to prevent soot build-up on said probe and said burner.

4. Apparatus as set forth in claim 1 wherein a wire spark probe is attached to the burner stem using a ceramic tube and block with said spark emanating from the tangent point of said wire spark probe to the side of said burner slit.

5. Apparatus as set forth in claim 1 wherein said direct wire probe sparks to a small pin-hole pilot burner located on the tip of said open flame burner near said burner slit wherein the spark emanates from the tangent point of said wire probe to said pin-hole pilot burner with said wire probe extending through the flame to provide ion flame sensing.

6. Apparatus in claim 1 wherein a single potting box comprising a gaslight igniter printed circuit board can be reconfigured to adapt to most gaslight igniter installations.

7. The potting box of claim 6 wherein said gaslight igniter is installed in the top of said lamp post with a manual gas valve holding said potting box and said burner in place.

8. The potting box of claim 6 wherein said solenoid valve is attached to the side of said potting box for installation in the base of said gaslight head.

9. The potting box of claim 6 wherein said solenoid valve is attached to the bottom of said potting box as a means of installing said apparatus of claim 1 in a very narrow gaslight head.

10. The potting box of claim 6 wherein said potting box ear is bent to hold said solenoid valve in position for several other configurations and installations.

11. A method of igniting two gaslight burners from a single igniter comprising two open flame burners, two probes, an igniter and solenoid valve.
(a) a method of generating sparks across the tip of said two burners by connecting the high voltage wire in series to said two spark probes.
(b) a method of assuring that said two burners light by using two photo-sensors in series with each sensor viewing one flame only.
(c) a method of assuring that the high voltage spark at said first burner is not shorted to burner ground after lighting due to ionized gas effect through said first burner stem by using an insulating coupler thus assuring that said second burner is ignited.

12. The apparatus of claim 1 wherein an automatic igniter/mantle burner apparatus for gaslights comprising an electronically controlled igniter, solenoid valve, mantle burner and spark probe.
(a) a method to assure that multiple mantles light, comprising a small pilot burner with multiple holes drilled in the top of said burner tube with a pilot burner ring mounted over said holes to expedite lighting from said spark probe to said pilot burner ring.
(b) a method of assuring that two mantles light, using two photo-sensors wired in series with each photo-sensor viewing only one mantle, such that sparking continues until said two mantles light.
(c) a method of using a direct wire probe from said igniter to said mantle pilot burner ring to transmit said high voltage spark to ignite said pilot burner.

13. The apparatus of claim 12 wherein said igniter, solenoid valve, mantle burner and probe are integrated into a single unit that is installed within the gaslight head using a quick connect fitting with said apparatus easily changed without tools.

14. The apparatus of claim 12, wherein said igniter is powered by batteries that are recharged by solar panels installed within said gaslight head, using energy from the burning mantles to charge said batteries and also by using energy from the sun.

15. A battery pack for powering said igniter of claim 12 wherein said battery pack can be either primary or rechargeable, with the batteries installed in a tube that can be inserted into the top of a post, through the base of said gaslight head.

16. Method for assembly of said apparatus of claim 12 wherein a quick connect fitting is used along with a manual valve that is drilled and tapped to accept said quick connect fitting, providing a receptacle for said apparatus with said manual valve held in place by a fastener.

17. Method for assembly of the apparatus of claim 12 wherein said manual valve is cut to insert said solenoid valve between said burner adapter and the remainder of said manual valve.

18. A gaslight plug-in burner assembly of claim 13 wherein said plug-in mantle burner assembly is a dimmer controlled mantle burner.
(a) a gas lamp plug-in burner receptacle whereby igniter operated open flame burners, igniter operated mantle burners, and manual burners can be interchanged without tools.

19. An apparatus used to limit the flow of gas to said gaslight or other appliance comprising a shutoff valve assembly with an orifice for restricting the gas flow in the gas line at its source to a rate necessary for operating said appliance while limiting gas flow in said gas line to a safe level in the event that said gas line is cut or damaged.
